(19) United States
(12) Patent Application Publication
(10) Pub. No.: US 2023/0398478 A1
(43) Pub. Date: Dec. 14, 2023

(54) FILTER MEDIUM COMPRISING A NONWOVEN ELECTRET

(71) Applicant: Neenah Gessner GMBH, Bruckmühl (DE)

(72) Inventors: Georg Geisberger, Bad Aibling (DE); Christian Hanfstingl, Bruckmühl (DE)

(21) Appl. No.: 18/036,369

(22) PCT Filed: Nov. 9, 2021
(86) PCT No.: PCT/EP2021/081114

§ 371 Date: May 10, 2023

(30) Foreign Application Priority Data
Nov. 10, 2020 (WO) PCT/EP2020/081644

(51) Int. Cl. B01D 39/16; D04H 1/4291; D04H 1/56

(52) U.S. Cl. CPC B01D 39/1623; D04H 1/4291; D04H 1/56; B01D 2239/0435; B01D 2239/0618; B01D 2239/0622; B01D 2239/1258; B01D 2239/1208; D10B 2505/04; D10B 2321/022; D10B 2401/10

(57) ABSTRACT

The present invention relates to a filter medium suitable for air filtration as well as related assemblies and methods.

### CROSS-REFERENCE TO RELATED APPLICATIONS

This application is a national stage application, filed under 35 U.S.C. § 371, of International Patent Application No. PCT/EP2021/081114 filed on Nov. 9, 2021, which claims the benefit of International Patent Application No. PCT/EP2020/081644, filed Nov. 10, 2020, the entire disclosures of which are incorporated herein by reference for all purposes.

### TECHNICAL FIELD

The present invention relates to a filter medium suitable for air filtration, a method for producing the filter as well as the use of the filter for air filtration.

### BACKGROUND

Filter media are used to remove undesirable materials (i.e. particles) from a liquid or gas by passing the liquid or gas through the filter media.

Filter media comprising nonwovens, based on polypropylene or polybutylene terephthalate polymers, are used in different fields of air filtration, e.g. as filters for interior spaces, vacuum cleaner bags or facemasks. In many cases, these filter media are additionally charged electrostatically to obtain nonwovens with electret properties to fulfill the high demands of particle filtration. In order to increase the charge, sometimes additives are added during the production of the filter medium. These additives are also called charge adjuvants and known examples thereof are hindered amides or a bis-stearoyl ethylenediamide. Corona charging, hydro charging or charging with polar liquid such as water and triboelectric charging or combinations thereof are known as methods for charging. Corona charging is the most frequently used method for large-scale production of electret filter media.

US 2012/0108714 A1 discloses a process to produce polypropylene nonwovens or yarns by extruding a mixture of polypropylene(s) and beta nucleating agent(s).

In US 2017/0145198 A1 a spunbond nonwoven fabric formed of an olefin-based polymer, preferably a propylene-based polymer, and a method for producing the same is disclosed. In this context, the use of various additives including a crystal nucleating agent is mentioned.

US 2004/0054040 A1 discloses plasticized polyolefins, such as propylene polymers, comprising a polyolefin and non-functionalized plasticizer. It is disclosed that the polyolefin composition may contain various additives.

US 2008/0311815 A1 discloses water-dispersible fibers and fibrous articles comprising a sulfopolyester, which may comprise additives, such as nucleating agents.

AU 2009/202306 A1 discloses plasticized polyolefins such as propylene polymers and/or butene polymers, wherein the polyolefin compositions may contain various additives, including nucleating agents.

WO 2006/118807 A1 discloses a method to make an article comprising combining a polymer with a polymer concentrate, wherein the polymer concentrate may comprise one or more additives, including nucleating agents.

EP 2 609 238 B1 discloses a nonwoven electret web comprising fibers made from a thermoplastic polymer material, wherein a hindered amine and an organic bis-amide derived from organic diamines which are reacted with two carboxylic acids are used as additives. Further, a process for manufacturing the nonwoven electret web is disclosed, wherein the fibers and/or the nonwoven web are treated with a polar liquid to obtain a nonwoven with an electret charge.

EP 3 553 214 A1 discloses an electret fiber sheet which is a nonwoven fabric formed from long fibers that are formed from a thermoplastic resin, wherein the long fibers contain a crystal nucleating agent.

However, for several applications in the field of air filtration, for instance air filtration in a facemask, filter media are required which exhibit not only excellent filtration properties but at the same time high air permeability and low pressure drop, respectively. Usually, to achieve a sufficient air permeability a filter medium with rather open structure is required. However, an open structure results in the disadvantageous effect of an insufficient filtration efficiency.

### SUMMARY

Therefore, it is an object of the present invention to provide a filter medium with excellent filtration efficiency and at the same time high air permeability and low pressure drop.

This object is solved by the filter medium according to the present invention, comprising at least one nonwoven electret, wherein the nonwoven electret comprises fibers made from a polymer material, wherein the polymer material comprises (a) at least one thermoplastic resin, (b) at least one charge adjuvant, and (c) at least one nucleating agent. The porosity of the nonwoven electret is preferably ≥90% and ≤98%. The filter medium can be used in many air filtration applications, such as filters for cabin air, room air purifier, vacuum cleaner bags, HVAC (Heating, Ventilation and Air Conditioning) and facemasks. Preferably, the filter medium according to the present invention can be used in a room air purifier, cabin air filter, HVAC filter and facemask.

The filter medium of the present invention can be used for air filtration, in particular for air filtration in air filter media, HVAC filters, cabin air filters and facemasks.

### Definitions

Herein the term “filter element” refers to any device that can be used for the process of filtration, i.e. the mechanical or physical process used for the separation of one substance from another, such as solids, liquids, and gases, with the aid of an interposed filter medium.

Herein, the term “filter medium” refers to the material used in a filter element or facemask in order to separate particles from their suspension in air or liquids.

Herein, the term “electret” refers to the class of dielectric materials containing quasi-permanent electric charge or molecular dipoles, which can generate internal and external electric fields. Accordingly, a “nonwoven electret” is a nonwoven as defined below showing the properties of an electret.

Herein, the term “dry-laid nonwoven” refers to all nonwovens that can be produced using dry-laying processes known to the skilled person for manufacturing filter media, i.e. a process for making a nonwoven web from dry fibers. Examples thereof are spunbond and meltblown nonwovens as well as carded web.

Herein, the term “wet-laid nonwoven” refers to all nonwovens that can be produced using wet-laying processes known to the skilled person for manufacturing filter media, i.e. a process of forming a web from a dispersion, such as an aqueous dispersion, of fibers.

Herein, the term “meltblown nonwoven” refers to all nonwovens that can be produced using meltblowing processes known to the skilled person for manufacturing filter media, i.e. a process in which a molten polymer is extruded into a hot gas stream of high velocity such that the molten polymer is converted into fibers.

Herein, the terms “spunbond nonwoven” and “spunlaid nonwoven” are used interchangeably and refer to all nonwovens that can be produced using spin-laying processes known to the skilled person for manufacturing filter media, i.e. a process of forming a web in which a polymeric melt or solution is extruded through spinnerets to form filaments which are laid down on a moving screen.

Herein, the term “carded web” refers to all nonwovens that can be produced using carding processes known to the skilled person for manufacturing filter media, i.e. a process for making fibrous webs in which the fibers are aligned essentially parallel to each other in the direction in which the machine produces the web (machine direction).

Herein, the term “corona charging” refers to a process of creating a nonwoven electret by exposing fibers made from a nonconductive polymeric material to an AC and/or DC corona-charging device, such that charges are placed on the fibers.

Herein, the term “water charging”, also called “hydro charging”, refers to a process of creating a nonwoven electret by exposing fibers to a mist of water, such that charges are placed on the fibers. The treatment can be performed either directly after formation of the fibers or after a nonwoven web has been formed from the fibers.

Herein, the term “charge adjuvant” refers to an agent added during the production of a charged nonwoven to increase the charges generated on the fibers.

Herein, the term “hindered amine” refers to a chemical compound comprising an amine as functional group, wherein large groups in proximity to the amine group slow down or inhibit a chemical reaction of this group.

Herein, the term “nucleating agent” refers to an agent added to a polymer melt which promotes crystallization of a semi-crystalline polymer from the melt.

Herein, the term “clarifier” refers to a nucleating agent which is partially soluble in a polymer melt and enhances the transparency of the polymer prepared from this melt.

Herein, the term “coarse prefilter” refers to a prefilter for coarse particle which collects the larger particles (typically filters with an average fiber diameter >15 μm).

### DETAILED DESCRIPTION OF THE EMBODIMENTS

The present invention provides a filter medium, comprising at least one nonwoven electret, wherein the nonwoven electret comprises fibers made from a polymer material, wherein the polymer material comprises (a) at least one thermoplastic resin, (b) at least one charge adjuvant, and (c) at least one nucleating agent.

Preferably, the polymer material can contain further additives selected from the group consisting of antioxidants, plasticizers, pigments, additives adjusting hydrophobicity/hydrophilicity, fillers, flame retardants or mixtures thereof.

The nonwoven electret of the present invention preferably has a porosity in the range 90%≤porosity≤98%, preferably 90%≤porosity≤94%. As is shown in the Examples below, a porosity in this rage clearly improves the performance of the filter media. In particular, a higher porosity results into a better efficiency to pressure drop ratio. Therefore, a porosity greater than 90% gives exceptionally features to filter media of the present invention.

Thermoplastic Resin

The thermoplastic resin in the sense of the present invention can be a homo- or copolymer consisting of only one kind of monomers in polymerized form (equal to a homopolymer) or a polymer consisting of different kinds of monomers in polymerized form (equal to a copolymer). The copolymers can be alternating copolymers, random copolymers, block copolymers or graft copolymers. Preferably, the thermoplastic resin is a homopolymer.

Preferably, the thermoplastic resin is a polyolefin resin or a polyester resin. Preferably, the polyolefin resin is a homopolymer. Preferably, the polyester resin is a homopolymer.

Preferably, the polyolefin resin is a polyethylene (PE) resin, a polypropylene (PP) resin, a polymethylpentene (PMP) resin, a polyisobutylene (PIB) resin or a polybutylene (PB) resin. More preferably, the polyolefin resin is a polypropylene (PP) resin. Even more preferably, the polyolefin resin is an isotactic polypropylene (PP) resin.

Preferably, the polyester resin is a polybutylene terephthalate (PBT) resin, a polyethylene terephthalate (PET) resin, a polylactic acid (PLA) resin or a polycarbonate (PC) resin. More preferably, the polyester resin is a polybutylene terephthalate (PBT) resin.

Various types of these thermoplastic resins can be used. For instance, it is possible to use metallocene polyolefins or Ziegler-Natta polyolefins. However, it is preferred that the thermoplastic resin is not a metallocene polyolefin. More preferably, the thermoplastic resin is a polypropylene resin which is not a metallocene polypropylene resin.

Charge Adjuvant

The charge adjuvant in the sense of the present invention can be any agent known in the art which serves as a trap for generated charges. However, the charge adjuvant has to be thermally stable at the extrusion temperature of the thermoplastic resin to avoid degradation or volatilization.

Preferably, the at least one charge adjuvant is a hindered amine. Typically, the hindered amine comprises derivatives of tetramethylpiperidine.

Preferably, the hindered amine belongs to the group of hindered amine (light) stabilizers (HA(L)S). More preferably, the charge adjuvant is selected from the group comprising the HA(L)S substances having the following CAS registry numbers: CAS 52829-07-9, CAS 71878-19-8, CAS 106990-43-6, CAS 63843-89-0, CAS 192268-64-7, CAS 90751-07-8, CAS 193098-40-7, CAS 79720-19-7, CAS 106917-30-0, CAS 167078-06-0, CAS 131290-28-3, CAS 109423-00-9, CAS 124172-53-8, CAS 199237-39-3, CAS 91788-83-9, CAS 64022-61-3, CAS 107119-91-5, CAS 100631-43-4, CAS 115055-30-6, CAS 100631-44-5, CAS 64338-16-5, CAS 85099-51-0, CAS 202483-55-4, CAS 76505-58-3, CAS 136504-96-6, CAS 71029-16-8, CAS 96204-36-3, CAS 130277-45-1, CAS 229966-35-2, CAS 85099-51-0, CAS 147783-69-5, CAS 154636-12-1, CAS 84214-94-8, CAS 99473-08-2, CAS 164648-93-5, CAS 164648-93-5 and CAS 42774-15-2. A particularly preferred HALS compound is poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]] (CAS 71878-19-8, Chimassorb® 944) or 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine (CAS 192268-64-7, Chimassorb® 2020).

Alternatively, the charge adjuvant may belong to the group of organic triazine compounds or oligomers with at least one additional nitrogen-containing group, as disclosed for example in WO 97/07272, in the following referred to as “triazine based charge adjuvant” or “TB-CA”.

Nucleating Agent

Preferably, the at least one nucleating agent is a clarifier.

Preferably, the at least one nucleating agent is selected from the group consisting of a benzoate salt, a sorbitol acetate, a rosin based nucleating agent, a carboxylic acid amide, a salt of an organophosphorous acid and mixtures thereof.

More preferably, the at least one nucleating agent is selected from the group consisting of a benzoate salt, a carboxylic acid amide, in particular an aromatic trisamide, a salt of an organophosphorous acid and mixtures thereof.

Preferred examples of benzoate salts are sodium benzoate, lithium benzoate, aluminum-hydroxy-bis(4-tert-butylbenzoate) and mixtures thereof.

Preferred examples of sorbitol acetates are dibenzylidene sorbitol and its derivatives, bis(p-methyl-benzylidene)-sorbitol (MDBS), bis(3,4-dimethyl-benzylidene)-sorbitol (DMDBS), bis(4-propylbenzylidene)propyl-sorbitol (also known as 1,2,3-tri-deoxy-4,6:5,7-bis-O-[(4-propylphenyl)methylene]-nonitol), and mixtures thereof.

Preferred examples of carboxylic acid amides are N,N′,N″-tris-(2-methylcylcohexyl)-1,2,3-propane-tricarboxamide, N,N′-dicyclo-hexylnaphthalene-dicarboxamide, and mixtures thereof, as well as the aromatic trisamides described below.

Preferred examples of aromatic trisamides are 1,3,5-benzene-tricarboxamide, 1,3,5-tris(2,2-dimethylpropionylamino)benzene (Irgaclear® XT 386), and mixtures thereof.

Preferred examples of salts of an organophosphorous acid are the sodium salt of di-(4-tert-butylphenyl)-phospate, the lithium or sodium salt of 2,2′-methylene-bis(4,6-di-tert-butylphenyl)-phosphate, the sodium salt of 2,4,8,10-tetra(tert-butyl)-6-bis-(4,6-di-tert-butylphenyl)phosphate (Irgastab® NA 287), aluminium-hydroxybis-[2,2′-methylene-bis(4,5-di-tert-butylphenyl)]-phosphate and mixtures thereof.

Preferred examples of nucleating agents are a benzoate salt, more preferably sodium benzoate; 1,3,5-tris(2,2-dimethylpropionylamino)benzene; a salt, more preferably the sodium salt, of 2,2′-methylene-bis(4,6-di-tert-butyl-phenyl)phosphate; and a salt, more preferably the sodium salt, of 2,4,8,10-tetra(tert-butyl)-6-bis-(4,6-di-tert-butylphenyl)phosphate.

Preferably, the polymer material comprises, at least two different nucleating agents, wherein the two nucleating agents are both clarifiers. Preferably, the polymer material comprises at least two different nucleating agents, wherein at least one nucleating agent is a clarifier and at least one nucleating agent is no clarifier.

Preferably, the nucleating agent which is no clarifier is selected from the group consisting of the salts of an organophosphorous acid described above, in particular the sodium salt of 2,2′-methylen-bis(4,6-di-tert-butylphenyl)-phosphate, the sodium salt of 2,4,8,10-tetra(tert-butyl)-6-bis-(4,6-di-tert-butylphenyl)phosphate and mixtures thereof.

Preferably, the clarifier is selected from the group consisting of a sorbitol acetate, a rosin based nucleating agent, an aromatic trisamide, and mixtures thereof. Preferred examples of these compounds are mentioned above. Sorbitol acetates and aromatic trisamides are preferred clarifiers.

Particular preferred examples of clarifiers aromatic trisamides, in particular 1,3,5-benzene-tricarboxamide, 1,3,5-tris(2,2-dimethylpropionylamino)benzene and mixtures thereof.

Preferably, a nucleating agent, which is a clarifier, preferably an aromatic trisamide, such as 1,3,5-benzene-tricarboxamide, 1,3,5-tris(2,2-dimethylpropionylamino)benzene and mixtures thereof, and a nucleating agent, which is no clarifier, preferably salts of an organophosphorous acid, such as the sodium salt of 2,2′-methylen-bis(4,6-di-tert-butylphenyl)-phosphate, the sodium salt of 2,4,8,10-tetra(tert-butyl)-6-bis-(4,6-di-tert-butylphenyl)phosphate, and mixtures thereof, are used in combination. Even more preferably, this combination of two different nucleating agents is combined with a HALS compound as charge adjuvant, such as poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]].

Nonwoven Electret

The nonwoven electret of the present invention comprises fibers made from a polymer material, wherein the polymer material comprises at least one thermoplastic resin (a), at least one charge adjuvant (b), and at least one nucleating agent (c) as described above.

The content of fibers made from a polymer material, wherein the polymer material comprises (a) at least one thermoplastic resin, (b) at least one charge adjuvant, and (c) at least one nucleating agent, comprised in the nonwoven electret, based on the total weight of fibers in the nonwoven electret, is preferably 80-100% by weight, more preferably 90-100% by weight, more preferably 95-100% by weight, more preferably 97-100% by weight, more preferably 98-100% by weight, more preferably 99-100% by weight, and most preferably 100% by weight.

Preferred examples of nonwoven electrets are meltblown nonwoven electrets and spunbond nonwoven electrets. More preferably, the nowoven electret is a meltblown nonwoven electret.

Preferred examples of the nonwoven electret are meltblown or spunbond nonwoven electrets comprising fibers made from a polymer material wherein the polymer material comprises 0.05-10% by weight, preferably 0.1-8% by weight and even more preferably 0.5-4% by weight of the at least one charge adjuvant and 0.005-10% by weight, preferably 0.01-6% by weight and even more preferably 0.02-2% by weight of the at least one nucleating agent, each based on the total weight of the polymer material. Preferably, the at least one nucleating agent is a clarifier. Even more preferably, the polymer material comprises 0.05-10% by weight, preferably 0.1-8% by weight and even more preferably 0.5-4% by weight of the at least one charge adjuvant, 0.005-5% by weight, preferably 0.005-3% by weight and even more preferably 0.01-1% by weight of a first nucleating agent, which is a clarifier, and 0.005-5% by weight, preferably 0.005-3% by weight and even more preferably 0.01-1% by weight of a second nucleating agent, which is no clarifier.

Preferred examples of the nonwoven electret are meltblown or spunbond nonwoven electrets comprising fibers made from a polymer material wherein the polymer material (PM) comprises the following components:
PM1: (a) PP, (b) HALS, (c) benzoate salt
PM2: (a) PP, (b) HALS, (c) carboxylic acid amide
PM3: (a) PP, (b) HALS, (c) salt of an organophosphorous acid
PM4: (a) PP, (b) TB-CA, (c) benzoate salt
PM5: (a) PP, (b) TB-CA, (c) carboxylic acid amide
PM6: (a) PP, (b) TB-CA, (c) salt of an organophosphorous acid
PM7: (a) PP, (b) HALS, (c) benzoate salt and carboxylic acid amide
PM8: (a) PP, (b) HALS, (c) benzoate salt and salt of an organophosphorous acid
PM9: (a) PP, (b) HALS, (c) carboxylic acid amide and salt of an organophosphorous acid
PM10: (a) PP, (b) TB-CA, (c) benzoate salt and carboxylic acid amide
PM11: (a) PP, (b) TB-CA, (c) benzoate salt and salt of an organophosphorous acid
PM12: (a) PP, (b) TB-CA, (c) carboxylic acid amide and salt of an organophosphorous acid
PM13: (a) PP, (b) HALS, (c) sorbitol acetate
PM14: (a) PP, (b) HALS, (c) sorbitol acetate and salt of an organophosphorous acid
PM15: (a) PP, (b) HALS (c) sorbitol acetate and carboxylic acid amide
PM16: (a) PP, (b) TB-CA, (c) sorbitol acetate
PM17: (a) PP, (b) TB-CA, (c) sorbitol acetate and salt of an organophosphorous acid
PM18: (a) PP, (b) TB-CA, (c) sorbitol acetate and carboxylic acid amide
PM 19: (a) PP, (b) Chimassorb 944, (c) Irgaclear XT368
PM 20: (a) PP, (b) Chimassorb 944, (c) Irgaclear XT368 and Irgastab NA287
PM 21: (a) PP, (b) Chimassorb 944, (c) sorbitol acetate

Particularly preferred examples are PM9, PM12, PM 13, PM 14, PM19, PM20 and PM21 more preferably PM9 and PM21 and most preferably PM9.

The meltblown nonwoven electret of the present invention comprises fibers with an average fiber diameter of 0.4-10 μm, preferably 0.6-5 μm and more preferably 0.8-3 μm.

For preparing the meltblown nonwoven comprising fibers made from the polymer material as described above any known technique for preparing meltblown nonwovens can be employed.

The spunbond nonwoven electret of the present invention comprises fibers having an average fiber diameter of 10-60 μm, preferably 15-40 μm.

For preparing the spunbond nonwoven comprising fibers made from the polymer material as described above any known technique for preparing spunbond nonwoven can be employed.

Suitable methods for charging are water charging, triboelectric charging and corona charging, with water charging being preferred for the present invention. Preferably, the water charging is performed by spraying water onto the fibers or onto the nonwoven web formed from the fibers. Preferably, the water charging is performed with deionized water.

It has been surprisingly found that by adding both a charge adjuvant and a nucleating agent to the thermoplastic resin the nonwoven electret shows an increase in efficiency and air permeability. At the same time, the efficiency of the meltblown nonwoven electret is equal or higher (depending on the amount of charge adjuvant and nucleating agent added) in comparison to a meltblown nonwoven prepared from a polymer material not containing both a charge adjuvant and a nucleating agent, whereas the parameters for production remain the same. Thus, the quality factor of the filter medium, i.e. the relation between the passage of particles through the filter, which is related to the collection efficiency, and the pressure drop due to blocking of the filter medium is improved. Therefore, the filter performance is improved.

Additional Layer

As is described below, the filter medium preferably comprises at least one additional layer of a wet-laid nonwoven or dry-laid nonwoven. A person skilled in the art knows, on account of his knowledge and experience, that the correct composition of this at least one additional layer should be specifically selected in each case according to the required filter properties. The at least one layer can consist of a plurality of plies, which are either produced in a paper machine, having a head box suitable for this purpose, and combined, or produced from individual webs, which are interconnected in a separate processing step. In this case, the individual plies can have different properties.

The wet-laid nonwoven or dry-laid nonwoven for the at least one additional layer of the filter medium according to the present invention comprises natural, synthetic, inorganic fibers or mixture thereof.

Examples of natural fibers are cellulose, cotton, wool, hemp, regenerated celluloses and fibrillated celluloses.

Inorganic fibers are, for example, glass fibers, basalt fibers and quartz fibers. Preferably, the inorganic fibers are glass fibers. The average fiber diameter of the inorganic fibers is 0.1 to 15 μm, preferably 0.6 to 10 μm.

Polyester fibers, polypropylene fibers, multicomponent fibers of which the individual components have different melting points, polyamide fibers and acrylic fibers for example are suitable as synthetic fibers.

Examples of polyester fibers are polybutylentherephthalate (PBT) fibers, polyethylentherephthalate (PET) fibers and polylactic acid (PLA) fibers.

Examples of preferred multicomponent fibers are PET/CoPET bicomponent fibers having core-sheath configuration.

The average fiber diameter of the synthetic fibers is typically from 3 to 30 μm, preferably 5 to 15 μm, and the cutting length is typically from 3-20 mm, preferably 4-12 mm.

In particular, dry-laid nonwovens include, for example, meltblown nonwovens, spunbond nonwovens (also called spunlaid nonwovens) and carded webs, which can be produced according to known manufacturing methods. Preferably, the at least one additional layer comprises a dry-laid nonwoven, more preferably a spunbond nonwoven. Preferably, the at least one additional layer consists of a dry-laid nonwoven, more preferably a spunbond nonwoven.

Suitable polymers to be used for the meltblown nonwovens, spunbond nonwovens and carded webs are, for example, polycarbonate, polyethylene terephthalate, polybutylene terephthalate, polyethylene naphthalate, polybutylene naphthalate, polyamide, polyphenylene sulfide, polyolefin, and polyurethane or mixture thereof.

Preferably, the meltblown nonwovens, spunbond nonwovens and carded webs comprise bicomponent fibers. Examples of preferred multicomponent fibers are PET/CoPET bicomponent fibers having core-sheath configuration. Preferably, the meltblown nonwovens, spunbond nonwovens and carded webs comprise polypropylene (PP) fibers, polyethylene terephthalate (PET) fibers and/or PET bicomponent (Bico PET/coPET) fibers. Preferably, the at least one additional layer consists of a spunbond nonwoven, wherein the spunbond nonwoven comprises polypropylene (PP) fibers, polyethylene terephthalate (PET) fibers and/or bicomponent fibers such as PET/coPET, PET/PP, PET/PBT, PP/PE and PET/PA bicomponent fibers.

The typical average fiber diameter for spunbond nonwovens is 10-60 μm, preferably 15-45 μm and even more preferably 20-40 μm.

The average fiber diameters for meltblown fibers are 0.5-10 m, preferably 0.5-5 μm, even more preferably 1-3 μm. Depending on the requirements, additives such as crystallisation promoters, dyes and/or charge enhancing additives can also be mixed into the polymers. In addition, the meltblown layer can be compressed using a calendar.

The average fiber diameters for carded webs are 5 to 50 μm.

Filter Medium

The filter medium comprises at least one nonwoven electret. Preferably, the at least one nonwoven electret is a meltblown layer.

Preferably, the filter medium comprises at least one additional layer of a wet-laid nonwoven or dry-laid nonwoven.

Preferably, the wet-laid nonwoven or dry-laid nonwoven comprised in the at least one additional layer of the filter medium comprises polypropylene (PP) fibers, polyethylene terephthalate (PET) fibers and/or PET/coPET bicomponent fibers.

In the context of this invention, “at least one additional layer of a wet-laid nonwoven or dry-laid nonwoven” preferably means that the filter medium comprises one to five additional layers of a wet-laid nonwoven or dry-laid nonwoven, more preferably one to four additional layers of a wet-laid nonwoven or dry-laid nonwoven, more preferably one to three additional layers of a wet-laid nonwoven or dry-laid nonwoven, more preferably two or three additional layers of a wet-laid nonwoven or dry-laid nonwoven, and most preferably two additional layers of a wet-laid nonwoven or dry-laid nonwoven.

The individual layers of the filter medium can be produced separately and combined afterwards; or each layer can be formed directly on the surface of the underlying layer; or these two methods can be combined. The combination of individual layers can be achieved by stacking and optionally by bonding, such as glueing, ultrasonic welding or thermocalander.

The compositions of the at least one nonwoven electret and the at least one additional layer are described in detail above.

Preferred examples of the filter medium, wherein the at least one nonwoven electret is in the form of a layer, are as follows:
I. A filter medium comprising one layer of a nonwoven electret and one additional layer of a wet-laid nonwoven or dry-laid nonwoven.
II. A filter medium consisting of one layer of a nonwoven electret and one additional layer of a wet-laid nonwoven or dry-laid nonwoven.
III. A filter medium comprising one layer of a nonwoven electret and two additional layers of a wet-laid nonwoven.
IV. A filter medium comprising one layer of a nonwoven electret and two additional layers of a dry-laid nonwoven.
V. A filter medium comprising one layer of a nonwoven electret, one additional layer of a wet-laid nonwoven and one additional layer of a dry-laid nonwoven.
VI. A filter medium consisting of one layer of a nonwoven electret and two additional layers of a wet-laid nonwoven.
VII. A filter medium consisting of one layer of a nonwoven electret and two additional layers of a dry-laid nonwoven.
VIII. A filter medium consisting of one layer of a nonwoven electret, one additional layer of a wet-laid nonwoven and one additional layer of a dry-laid nonwoven.
IX. Any of the filter media III to VIII above, wherein the layer of a nonwoven electret is disposed between the two additional layers of a wet-laid nonwoven or between the two additional layers of a dry-laid nonwoven or between the one additional layer of a wet-laid nonwoven and the one additional layer of a dry-laid nonwoven.

Preferably, in any of the filter media I to IX stated above, the nonwoven electret is a meltblown nonwoven electret or a spunbond nonwoven electret. More preferably, the nonwoven electret is a meltblown nonwoven electret.
X. A filter medium consisting of one layer of a meltblown nonwoven electret and one additional layer of a spunbond nonwoven.
XI. A filter medium consisting of one layer of a meltblown nonwoven electret and two additional layers of a spunbond nonwoven, wherein the meltblown nonwoven electret is disposed between the two additional layers of a spunbond nonwoven. (SMS)
XII. A filter medium consisting of one layer of a meltblown nonwoven electret, one additional layer of a spunbond nonwoven and one additional layer of a meltblown nonwoven, wherein the additional layer of a meltblown nonwoven is a coarse prefilter and the meltblown nonwoven electret is disposed between the additional layer of a spunbond nonwoven and the additional layer of a meltblown nonwoven. (SMM)
XIII. A filter medium consisting of one layer of a meltblown nonwoven electret, two additional layers of a spunbond nonwoven and one additional layer of a meltblown nonwoven, wherein the additional layer of a meltblown nonwoven is a coarse prefilter and the meltblown nonwoven electret is disposed between the additional layer of a spunbond nonwoven and the additional layer of a meltblown nonwoven and the two additional layers of a spunbond nonwoven are the two outermost layers. (SMMS)
XIV. Any of the filter media I to XIII above, wherein the nonwoven electret is any one selected from the group consisting of PM1 to PM21, preferably PM9, PM12, PM19 and PM21, more preferably PM9 and PM21 and most preferably PM9.
XV. Any of the filter media I to XIV above, wherein the dry-laid nonwoven is a spunbond nonwoven.
XVI. Any of the filter media I to XV above, wherein the spunbond nonwoven comprises polypropylene (PP) fibers, polyethylene terephthalate (PET) fibers and/or PET/coPET bicomponent fibers.

The layer thickness of the at least one nonwoven electret is preferably 0.05-1.0 mm, more preferably 0.1-1.0 mm, more preferably 0.2-0.9 mm, and most preferably 0.2-0.7 mm.

The layer thickness of the at least one additional layer is preferably 0.05-1.0 mm, more preferably 0.1-0.9 mm, more preferably 0.2-0.8 mm, and most preferably 0.3-0.7 mm.

The thickness of the total filter medium for a filter medium comprising one layer of a nonwoven electret and one additional layer is preferably 0.1-2.0 mm, more preferably 0.2-1.8 mm, more preferably 0.3-1.6 mm, more preferably 0.4-1.4 mm, and most preferably 0.4-1.0 mm.

The thickness of the total filter medium for a filter medium comprising one layer of a nonwoven electret and two additional layers is preferably 0.15-3.0 mm, more preferably 0.3-2.8 mm, more preferably 0.5-2.6 mm, more preferably 0.6-1.2.

The air permeability of the at least one nonwoven electret is preferably 30-4.000 L/m²s, more preferably 50-3.000 L/m²s, more preferably 100-2.000 L/m²s, and most preferably 200-1.500 L/m²s.

The air permeability of the at least one additional layer is preferably 2.000-15.000 L/m²s, more preferably 3.000-12.000 L/m²s, more preferably 3.500-10.000 L/m²s, and most preferably 4.000-8.000 L/m²s.

The air permeability of the total filter medium is preferably 20-3.000 L/m²s, more preferably 40-2.500 L/m²s, more preferably 80-1.700 L/m²s, and most preferably 180-1.300 L/m²s.

The basis weight of the at least one nonwoven electret is preferably 4-50 g/m², more preferably 8-40 g/m², more preferably 10-35 g/m², and most preferably 15-30 g/m².

The basis weight of the at least one additional layer is preferably 10-170 g/m², more preferably 20-140 g/m², more preferably 30-120 g/m², and most preferably 50-100 g/m².

The basis weight of the total filter medium is preferably 18-220 g/m², more preferably 30-180 g/m², more preferably 50-160 g/m², and most preferably 70-120 g/m².

The efficiency, also called “collection efficiency”, of the at least one nonwoven electret is preferably 20-99.999995%, more preferably 40-99.99995%, more preferably 60-99.9995%, and even more preferably 70-99.995%.

The efficiency of the at least one additional layer is preferably 0-30%, more preferably 1-25%, more preferably 2-20%, and even more preferably 3-10%.

The efficiency of the total filter medium is preferably 25-99.999995%, more preferably 45-99.99995%, more preferably 65-99.9995%, and even more preferably 75-99.995%.

Filter Element

The filter element of the present invention comprises at least one filter medium as described above. Preferably, the filter element comprises one filter medium as described above. In addition, the filter element usually comprises a substrate. The substrate can be disposed on one side of the filter medium, on two or more sides of the filter medium or can surround the filter medium entirely. Suitable materials to be used as the substrate include plastic frames, metal frames, nonwoven frames or edge bands, paper frames, cotton frames, stripes, bands, ribbon or similar.

Method for Producing the Filter Medium

The filter medium of the present invention can be produced by any technique known in the art. For example, the filter medium of the present invention can be prepared by a method comprising the following steps:
(i) providing a polymer material, comprising:
   (a) at least one thermoplastic resin,
   (b) at least one charge adjuvant and
   (c) at least one nucleating agent;
(ii) subjecting the polymer material of step (i) to a nonwoven forming process;
(iii) subjecting the nonwoven formed in step (ii) to a process of electrostatic charging to obtain a nonwoven electret;
(iv) optionally providing one or more additional layers of a wet-laid nonwoven or dry-laid nonwoven, and
(v) optionally laminating the nonwoven electret obtained in step (iii) and the one or more additional layers of step (iv) in a desired order.

In a further step, the filter medium obtained in this way can be laminated onto a suitable substrate, as discussed above, to obtain a filter element. Alternatively, the lamination step (v) can be performed directly on the substrate.

Preferably, the nonwoven forming process in step (ii) is a meltblown process or a spunbond process, even more preferably a meltblown process, such that in step (iii) a meltblown nonwoven electret or a spunbond nonwoven electret, more preferably a meltblown nonwoven electret, is obtained.

As is described above, the nonwoven forming process of step (ii) can be any nonwoven forming process known in the art, such as any spunbond process or meltblown process known in the art. Accordingly, the process of electrostatic charging of step (iii) can be any process of electrostatic charging known in the art. As examples of the process of electrostatic charging water charging, triboelectric charging and corona charging can be mentioned. For the process of the present invention, water charging is preferred. Further, instead of producing the nonwoven electret and the optional one or more additional layers individually and laminating them onto a substrate it is also possible to form one or some or all of these layers directly on the surface of the underlying layer or underlying substrate.

### Preferred Embodiments

A. A filter medium, comprising at least one nonwoven electret, wherein the nonwoven electret comprises fibers made from a polymer material, wherein the polymer material comprises:
(a) at least one thermoplastic resin,
(b) at least one charge adjuvant, and
(c) at least one nucleating agent.

B. The filter medium according to A, wherein the porosity of the nonwoven electret is ≥90% and ≤98%.

C. The filter medium according to any one of A to B, wherein the porosity of the nonwoven electret is ≥90% and ≤94%.

D. The filter medium according to any one of A to C, wherein the thermoplastic resin is a polyolefin resin or a polyester resin.

E. The filter medium according to any one of A to D, wherein the thermoplastic resin is a polyolefin resin selected from the group consisting of polyethylene (PE) resin, a polypropylene (PP) resin, a polymethylpentene (PMP) resin, a polyisobutylene (PIB) resin or a polybutylene (PB) resin. More preferably, the polyolefin resin is a polypropylene (PP) resin. Even more preferably, the polyolefin resin is an isotactic polypropylene (PP) resin.

F. The filter medium according to any one of A to E, wherein the at least one charge adjuvant is a hindered amine.

G. The filter medium according to F, wherein the hindered amine is selected from poly[[6-[(1,1,3,3-tetramethylbutyl)amino]-1,3,5-triazine-2,4-diyl][(2,2,6,6-tetramethyl-4-piperidinyl) imino]-1,6-hexanediyl[(2,2,6,6-tetramethyl-4-piperidinyl) imino]] or 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine.

H. The filter medium according to any one of A to G, wherein the at least one nucleating agent is a clarifier.

J. The filter medium according to any one of A to H, wherein the at least one nucleating agent is selected from the group consisting of a benzoate salt, a sorbitol acetate, a rosin based nucleating agent, a carboxylic acid amide, or a salt of an organophosphorous acid and mixtures thereof.

K. The filter medium according to any one of A to J, wherein the at least one nucleating agent is elected from the group consisting of sorbitol acetates, aromatic trisamides and mixtures thereof.

L. The filter medium according to any one of A to K, wherein the at least one nucleating agent is selected from the group consisting of dibenzylidene sorbitol and its derivatives, bis(p-methyl-benzylidene)-sorbitol (MDBS), bis(3,4-dimethyl-benzylidene)-sorbitol (DMDBS), bis(4-propylbenzylidene)propyl-sorbitol (also known as 1,2,3-tri-deoxy-4,6:5,7-bis-O-[(4-propylphenyl)methylene]-nonitol), 1,3,5-benzene-tricarboxamide, 1,3,5-tris(2,2-dimethylpropionylamino)benzene, and mixtures thereof.

M. The filter medium according to any one of A to L, wherein the at least one nucleating agent is 1,3,5-benzene-tricarboxamide, 1,3,5-tris(2,2-dimethylpropionylamino)benzene.

N. The filter medium according to any one of A to M, wherein the polymer material comprises at least two different nucleating agents.

O. The filter medium according to N, wherein one of the at least two different nucleating agents is a clarifier.

P. The filter medium according to any one of A to O, wherein the polymer material comprises 0.05-10% by weight of the at least one charge adjuvant and 0.05-10% by weight of the at least one nucleating agent, each based on the total weight of the polymer material.

Q. The filter medium according to any one of A to P, wherein the at least one nonwoven electret is a meltblown layer.

R. The filter medium according to any one of A to Q, which further comprises at least one additional layer of a wet-laid nonwoven or dry-laid nonwoven.

S. The filter medium according to R, wherein the wet-laid nonwoven or dry-laid nonwoven comprises polypropylene (PP) fibers, polyethylene terephthalate (PET) fibers and/or PET bicomponent (Bico PET/coPET) bicomponent fibers.

T. The filter medium according to R and S, wherein the at least one dry-laid nonwoven is a spunbond nonwoven.

U. The filter medium according to R to T, comprising, or consisting of, the nonwoven electret and one spunbond layer.

V. The filter medium according to R to T, comprising, or consisting of, the nonwoven electret and 2 spunbond layer.

W. The filter medium according to any one of A to V, wherein the air permeability of the filter medium is 20 to 3000 L/m2s according to DIN EN ISO 9237 (1995).

X. The filter medium according to any one of A to W, wherein the collection efficiency of the at least one nonwoven electret is 20-99.99%.

Y. Use of the filter medium according to any one of A to X for air filtration.

Z. Use of the filter medium according to Y in air filter media, HVAC filters (Heating, Ventilation and Air Conditioning), cabin air and face masks.

### EXAMPLES

### Examples 1 and 2

A polymer material comprising polypropylene, 0.15% by weight of 1,3,5-tris(2,2-dimethylpropionylamino)benzene, which is a clarifier (Irgaclear® XT 386) and 1% by weight of a hindered amine (poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]), Chimassorb® 944) was prepared. The polymer material was subjected to a meltblown process after which the fibers were treated with a mist of deionized water immediately after formation in the extruder. The meltblown nonwoven electrets V24, V25 and V26 were obtained. The different samples were obtained by changing the screen belt and/or the polymer throughput, as known to the skilled person working in the field of meltblown processes. The average fiber diameter was 2.3 μm for all 3 samples.

### Example 3a

A polymer material comprising polypropylene, 0.15% by weight of 1,3,5-tris(2,2-dimethylpropionylamino)benzene, which is a clarifier (Irgaclear® XT 386), 0.3% by weight of the sodium salt of 2,4,8,10-tetra(tert-butyl)-6-bis-(4,6-di-tert-butylphenyl)phosphate, which is not a clarifier (Irgastab® NA 287) and 1% by weight of a hindered amine (poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]), Chimassorb® 944) was prepared. The polymer material was subjected to a meltblown process after which the fibers were treated with a mist of deionized water immediately after formation in the extruder. A meltblown nonwoven electret V21a was obtained. The average fiber diameter of nonwoven V21a is 2.7 μm.

### Example 3b

Example 3b was performed in the same manner as Example 3a, with the exception that the thickness was adjusted to 0.35 mm. A meltblown nonwoven electret V21b was obtained. The average fiber diameter of nonwoven V21b is 2.7 μm.

### Example 4

A polymer material comprising polypropylene, 0.15 by weight of the sodium salt of 2,4,8,10-tetra(tert-butyl)-6-bis-(4,6-di-tert-butylphenyl)phosphate, which is not a clarifier (Irgastab® NA 287) and 1% by weight of a hindered amine (poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]), Chimassorb® 944) was prepared. The polymer material was subjected to a meltblown process after which the fibers were treated with a mist of deionized water immediately after formation in the extruder. Meltblown nonwoven electrets V5, V9, V11 and V13 were obtained. The average fiber diameter of nonwovens V5, V9, V11 and V13 is 2.7 μm.

### Comparative Example 1a

A polymer material comprising polypropylene (the same batch as in Example 1), no nucleating agent and no charge adjuvant was prepared. The polymer material was subjected to a meltblown process under the same production parameters as in Example 1 with the exception that the fibers were subjected to corona charging instead of a treatment with a mist of deionized water immediately after formation in the extruder. A meltblown nonwoven electret V1a was obtained.

### Comparative Example 1b

Comparative Example 1b was performed in the same manner as Comparative Example 1a, with the exception that the thickness was adjusted to 0.5 mm. A meltblown nonwoven electret V1b was obtained.

### Comparative Example 2a

A polymer material comprising polypropylene (the same batch as in Example 1) and 1% by weight of Chimassorb® 944 was prepared. The polymer material was subjected to a meltblown process under the same production parameters as in Example 1 during which the fibers were treated with a mist of deionized water immediately after formation in the extruder. A meltblown nonwoven electret V3a was obtained.

### Comparative Example 2b

Comparative Example 2b was performed in the same manner as Comparative Example 2a, with the exception that the thickness was adjusted to 0.4 mm. A meltblown nonwoven electret V3b was obtained.

The basis weight, the thickness, porosity and the air permeability of the obtained media were determined and are given in Table 1. Further, the collection efficiency and the pressure drop were measured according to DIN 71460-1 (2006). The sample size was 100 cm², the face velocity 20 cm/s and for the efficiency test a KCl (1%) aerosol was used. Measurement time was 1 minute. Results are given in Table 2.

Test results of measuring breathing resistance and penetration according to EN 149:2009 with paraffin oil as test aerosol, an air flow rate of 95 L/min, a sample size of 100 cm² and a measuring time of 210 sec. are given in Table 3.

The advantages of a meltblown nonwoven electret prepared from a polymer material comprising three additives, i.e. one charge adjuvant and two nucleating agents, wherein one nucleating agent is a clarifier and the other nucleating agent is no clarifier, in comparison to a meltblown nonwoven electret prepared from a polymer material comprising two additives, i.e. one charge adjuvant and one nucleating agent, can been seen when comparing V21b to V26 (nucleating agent is a clarifier) or to V5/V9/V11/V13 (nucleating agent is no clarifier). These meltblown nonwoven electrets all have a comparable thickness. V21b exhibits very good efficiency associated with an extremely high air permeability and respectively low pressure drop.

Further, comparing the meltblown nonwoven electrets V24 and V25 shows that a higher porosity results into a much better efficiency to pressure drop ratio. The same counts for a comparison of the meltblown nonwoven electrets V11 and V13 with V21b.

TABLE 1
Properties of meltblown nonwoven electrets

| Sample | V1a | V1b | V3a | V3b | V21a | V21b | V24 | V26 | V25 | V5 | V9 | V11 | V13 |
|---|---|---|---|---|---|---|---|---|---|---|---|---|---|
| Basis weight | 30 | 25 | 30 | 25 | 30 | 25 | 30 | 24.5 | 24.5 | 25 | 25 | 25 | 25 |
| [g/m²] | | | | | | | | | | | | | |
| Thickness [mm] | 0.35 | 0.5 | 0.43 | 0.4 | 0.66 | 0.35 | 0.48 | 0.28 | 0.18 | 0.225 | 0.202 | 0.23 | 0.235 |
| Air permeability | 700 | 390 | 800 | 400 | 1300 | 900 | 330 | 270 | 190 | 275 | 361 | 368 | 413 |
| [L/m²/s] | | | | | | | | | | | | | |
| Porosity | 90% | 94% | 92% | 93% | 95% | 92% | 93% | 90% | 85% | 88% | 86% | 88% | 88% |

TABLE 2
Collection efficiency and pressure drop of meltblown nonwoven electrets

| Sample | V1a | V1b | V3a | V3b | V21a | V21b | V24 | V26 | V25 | V5 | V9 | V11 | V13 |
|---|---|---|---|---|---|---|---|---|---|---|---|---|---|
| Collection | 65 | 51 | 71 | 91 | 78 | 94 | 99.8 | 99.8 | 99.7 | 80 | 63 | 76 | 75 |
| efficiency [%] | | | | | | | | | | | | | |
| pressure drop | 69 | 105 | 60 | 90 | 33 | 55 | 131 | 165 | 240 | 100 | 80 | 80 | 70 |
| [Pa] | | | | | | | | | | | | | |

TABLE 3
Breathing resistance and penetration according to
EN149: 2009 with paraffin oil as test aerosol

| | | In W1 | In W2 | Out |
|---|---|---|---|---|
| | Penetration | (l/min)¹ | (l/min)² | (l/min)³ |
| Sample | % | 30 Pa | 95 Pa | 160 Pa |
| V1a | 33.64 | 16 | 51 | 88 |
| V1b | 39.53 | 21 | 63 | 107 |
| V3a | 18.71 | 11 | 37 | 61 |
| V3b | 4.42 | 20 | 61 | 101 |
| V5 | 15.28 | 22 | 66 | 111 |
| V9 | 28.28 | 16 | 50 | 85 |
| V11 | 19.99 | 22 | 67 | 112 |
| V13 | 19.94 | 20 | 62 | 104 |
| V21a | 15.44 | 7 | 21 | 34 |
| V21b | 5.89 | 12 | 37 | 62 |
| V24 | 0.33 | 31 | 100 | 149 |
| V26 | 0.23 | 34 | 110 | 172 |
| V25 | 0.26 | 55 | 172 | 272 |

¹Pressure drop in Pa during breathing in with an air flow of 30 L/min
²Pressure drop in Pa during breathing in with an air flow of 95 L/min
³Pressure drop in Pa during breathing out with an air flow of 160 L/min

As can be seen from Table 3, sample V25 has a higher breathing resistance than V24 and V26.

Further, the use of 3 additives, as in examples V21a and V21b, is particularly preferable for application as HVAC and cabin air filter medium (i.e. it has a very good efficiency associated with an extremely high air permeability and respectively low pressure drop).

As can be seen in the Examples and Comparative Examples, with the nonwoven electret of the present invention a very high air permeability and at the same time a high collection efficiency is achieved. Thus, the nonwoven electret of the present invention is particularly suited for effective filtration of air filtration, in particular in a facemask, a HVAC filter and a cabin air filter.

Test Methods

Average fiber diameters are measured as follows:

Device: scanning electron microscope (SEM) (such as for example a “Phenom Fei”) with an associated software allowing to determine diameter of selected fibers. An example of such type of software is Fibermetric V2 but any other software can be used.

Sampling: 5 different area of the filter medium will be analyzed over the web width.

Sample sputtering: Random recording of optical images, these areas are scanned with a 1000× magnification.

Fiber diameter determination via “one click” method, every fiber has to be recorded once; At least 500 fibers are evaluated in total and the mean value of these corresponds to the average fiber diameter.

The layer thickness of the at least one nonwoven electret and of the at least one additional layer as well as the thickness of the total filter medium is measured according to DIN EN ISO 9073-2:1997 (0.5 kPa).

The air permeability is measured according to DIN EN ISO 9237 (1995) at a pressure difference of 200 Pa, a sample size of 20 cm² and a testing head of 20 cm². Any suitable instrument can be used as for example a Textest FX3300 instrument.

The basis weight is measured according to DIN EN 29073 (1992).

The collection efficiency and the pressure drop were measured according to DIN 71460-1 (2006). Any suitable instrument can be used as for example a Palas Hepa MFP-2100 HEPA test bench. Test conditions: Sample size: 100 cm², Test aerosol: KCl, 1%; Face velocity: 20 cm/s; Measurement time: 1 minute; Efficiency @ 0.3p m particle size.

Breathing resistance and penetration were measured according to EN149:2009 with paraffin oil as test aerosol, an air flow rate of 95 L/min, a sample size of 100 cm² and a measuring time of 210 sec. Any suitable instrument can be used as for example a Lorenz Facemask test bench.

The porosity is the three-dimensional volume void fraction of the nonwoven. It is calculated from the actual density of the nonwoven and the average density of the fibers used according to the following formula:

Porosity=(1−density nonwoven [g/cm³]/density fibers [g/cm³])·100%

The density of the nonwoven is calculated from the basis weight and thickness as follows:

Density nonwoven (g/cm³)=(Basis weight (g/m²)·0.0001)/(Thickness (mm)·0.1)

1. A filter medium, comprising at least one nonwoven electret,
wherein the nonwoven electret comprises fibers made from a polymer material,
wherein the polymer material comprises:
(a) at least one thermoplastic resin,
(b) at least one charge adjuvant, and
(c) at least one nucleating agent,
wherein the porosity of the nonwoven electret is ≥90% and ≤98%.

2. The filter medium according to claim 1, wherein the thermoplastic resin is a polyolefin resin or a polyester resin.

3. The filter medium according to claim 1 wherein the at least one charge adjuvant is a hindered amine.

4. The filter medium according to claim 1, wherein the at least one nucleating agent is a clarifier.

5. The filter medium according to claim 1, wherein the at least one nucleating agent is selected from the group consisting of a benzoate salt, a sorbitol acetate, a rosin based nucleating agent, a carboxylic acid amide, a salt of an organophosphorous acid and mixtures thereof.

6. The filter medium according to claim 1, wherein the polymer material comprises at least two different nucleating agents.

7. The filter medium according to claim 1, wherein the polymer material comprises 0.05-10% by weight of the at least one charge adjuvant and 0.005-10% by weight of the at least one nucleating agent, each based on the total weight of the polymer material.

8. The filter medium according to claim 1, wherein the at least one nonwoven electret is a meltblown layer.

9. The filter medium according to claim 1, which further comprises at least one additional layer of a wet-laid nonwoven or dry-laid nonwoven.

10. The filter medium according to claim 9, wherein the wet-laid nonwoven or dry-laid nonwoven comprises polypropylene (PP) fibers, polyethylene terephthalate (PET) fibers and/or PET/coPET bicomponent fibers.

11. The filter medium according to claim 1, wherein the air permeability of the filter medium is 20 to 3000 L/m²s, according to DIN EN ISO 9237 (1995).

12. The filter medium according to claim 1, wherein the collection efficiency of the at least one nonwoven electret is 20-99.999995%, according to DIN 71460-1 (2006).

13. Use of the filter medium according to claim 1, for air filtration.

14. Use of the filter medium according to claim 13 in air filter media, HVAC filters (Heating, Ventilation and Air Conditioning), cabin air and face masks.

15. The filter medium according to claim 1, wherein the porosity of the nonwoven electret is ≥90% and ≤98%.
